(19) United States
(12) Patent Application Publication
(10) Pub. No.: US 2011/0255113 A1
(43) Pub. Date: Oct. 20, 2011

(54) Document Tag Based Destination Prompting and Auto Routing for Document Management System Connectors

(75) Inventors: Hongfeng Wei, Cerritos, CA (US); William Su, Riverside, CA (US); Ajit Sodhi, Irvine, CA (US)

(73) Assignees: Toshiba Tec Kabushiki Kaisha, Shinagawa-ku (JP); Kabushiki Kaisha Toshiba, Minato-ku (JP)

(21) Appl. No.: 13/015,353

(22) Filed: Jan. 27, 2011

Related U.S. Application Data
(60) Provisional application No. 61/324,459, filed on Apr. 15, 2010.

(51) Int. Cl. G06F 3/12; G06F 17/30

(52) U.S. Cl. 358/1.13; 707/812; 707/E17.005; 358/1.15; 358/1.14

(57) ABSTRACT

Systems and methods for electronic document routing using a multifunction peripheral are disclosed. An electronic document including a document tag is accepted. A document tag is automatically identified using optical character recognition within the electronic document. The document tag is then displayed to the user. The electronic document is stored in a storage location for the electronic document previously associated with the document tag or in a user-input storage location in response to a prompt.

### RELATED APPLICATION INFORMATION

This patent claims priority from U.S. Patent Application No. 61/324,459 entitled “Document Tag Based Destination Prompting and Auto Routing for Document Management System Connectors” filed Apr. 15, 2010.

### BACKGROUND

1. Field

This disclosure relates to document tag based prompting and auto routing for document management system connectors.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organizations networks which also include various other workstations, servers and peripherals. An MFP may also provide remote document processing services to external or network devices.

Apart from MFPs, many organizations use a document management system, which is a software system running on one or more server computers which allows a number of users to share and control electronic documents. The document management system may be served based, client-server, or distributed in other ways. Typical document management systems store documents in a database and manage the documents as database objects. Document management systems typically uniquely identify individual documents, and the database stores metadata such as document title, author, date created, and date last edited which are available through the document management system.

### DESCRIPTION OF THE DRAWINGS

FIG. 1 is a diagram of a system for document tag based destination prompting and auto routing.

FIG. 2 is a block diagram of an MFP.

FIG. 3 is a block diagram of a computing device.

FIG. 4 is a block diagram of a software system for document tag based destination prompting and auto routing.

FIG. 5 is a functional diagram of a system for document tag based destination prompting and auto routing.

FIG. 6 is a flowchart for creation of document tags.

FIG. 7 is a flowchart for destination prompting and auto routing.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Systems and methods for document routing using an MFP are disclosed. A document including a document tag is accepted. A document tag is automatically identified using optical character recognition within the document. The document tag is then displayed to the user. The document is stored in a storage location for the document previously associated with the document tag or in a user-input storage location in response to a prompt.

Description of Apparatus

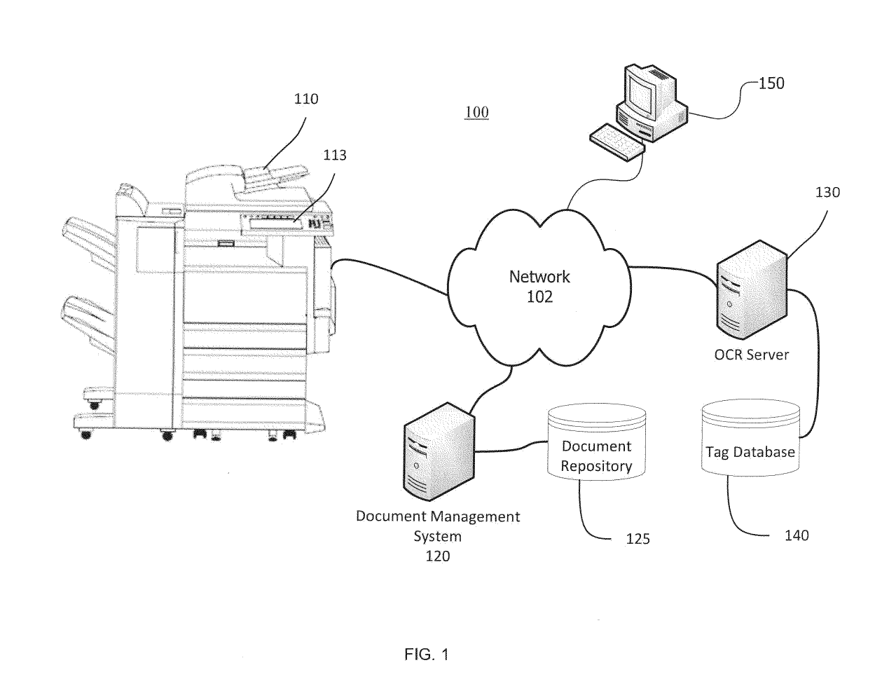

Referring now to FIG. 1 there is shown a diagram of a system 100 for document tag based destination prompting and auto routing. The system 100 includes an MFP 110, an OCR server 140, a tag database 140, a document management system 120, a document repository 125, and a client computer 150, all interconnected by a network 102. The system 100 may be implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WiMax, Bluetooth, the public switched telephone network, a proprietary communications network, infrared, and optical.

The MFP 110 may be equipped to receive portable storage media such as USB drives. The MFP 110 includes a user interface 113 subsystem which communicates information to and receives selections from users. The user interface subsystem 113 has a user output device for displaying graphical elements, text data or images to a user and a use input device for receiving user inputs. The user interface subsystem 113 may include a touchscreen, LCD display, touch-panel, alpha-numeric keypad and/or an associated thin client through which a user may interact directly with the MFP 110.

The OCR server 130 is software operating on a server computer which performs optical character recognition (OCR) of electronic documents. The tag database 140 is software operating on a server computer which stores tags and their associated electronic document storage locations.

The document management system 120 is a document management system. The document repository 125 is one or more databases that store documents for the document management system 120. The document repository 125 is software operating on one or more electronic file storage systems and may be or include one or more of a file server, hard disk drive, tape drive, network shared storage drive, cloud storage or remote data storage.

The client computer 150 may be a PC, thin client or other device. The client computer 150 is representative of one or more end-user devices and may be considered separate from the system 100.

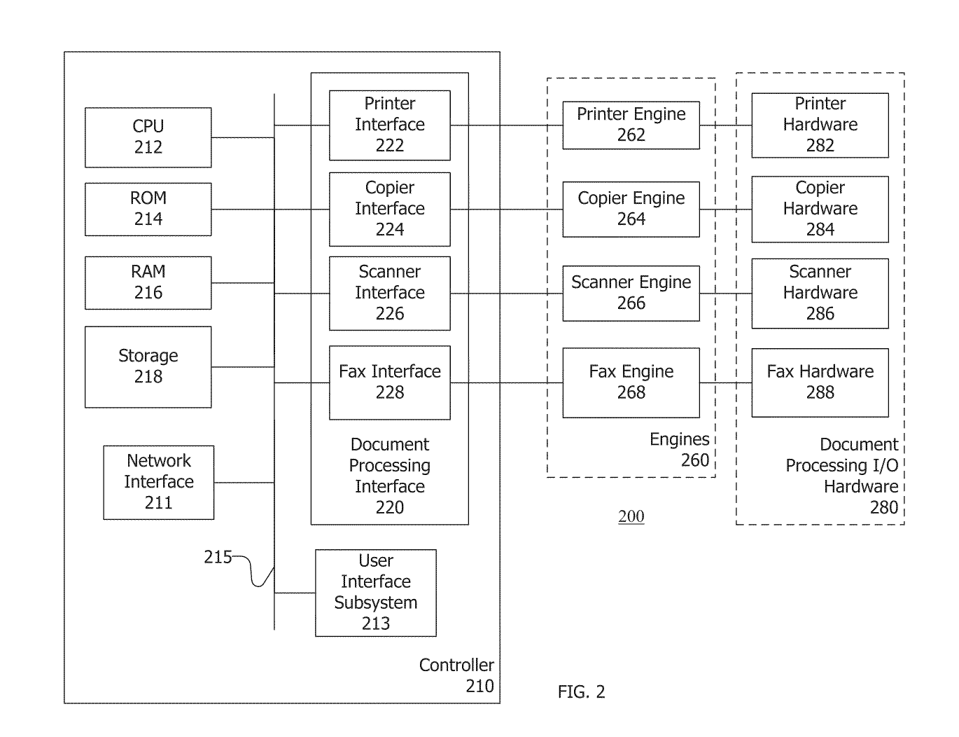

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 208, a network interface 211, a bus 215, a user interface subsystem 224 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 of FIG. 1 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 208 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 228, 230, 232 and 234. The printer interface 222, copier interface 224, scanner interface 226, and fax interface 228 are examples of document processing interfaces. The interfaces 228, 230, 232 and 234 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

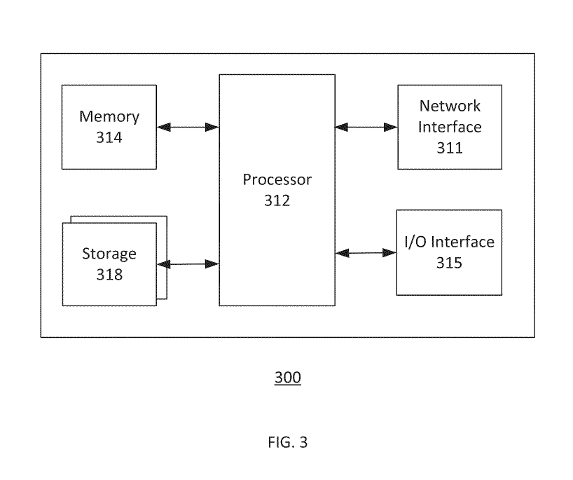

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102.

The I/O interface 315 interfaces the processor 312 to peripherals (not shown) such as displays, keyboards and USB devices.

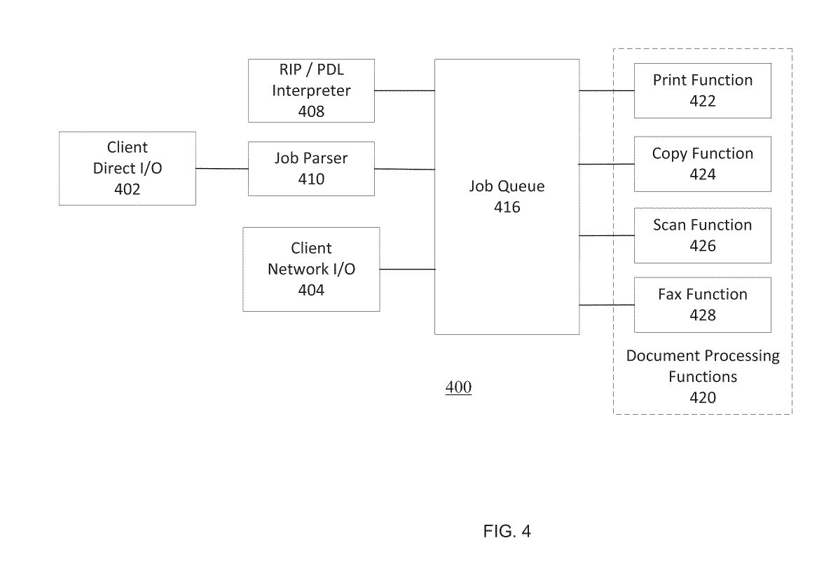

Turning now to FIG. 4 there is shown a block diagram of a software system 400 of an MFP for document tag based destination prompting and auto routing which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface 116), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 420 enables the MFP to print documents and implements each of the various functions related to that process. These include stapling, collating, hole punching, and similar functions. The copy function 422 enables the MFP to perform copy operations and all related functions such as multiple copies, collating, 2 to 1 page copying or 1 to 2 page copying and similar functions. Similarly, the scan function 424 enables the MFP to scan and to perform all related functions such as shrinking scanned documents, storing the documents on a network or emailing those documents to an email address. The fax function 426 enables the MFP to perform facsimile operations and all related functions such as multiple number fax or auto-redial or network-enabled facsimile.

Some or all of the document processing functions 420 may be implemented on a client computer. The user interface for some or all document processing functions may be provided locally by the MFP's user interface subsystem though the document processing function is executed by a computing device separate from but associated with the MFP.

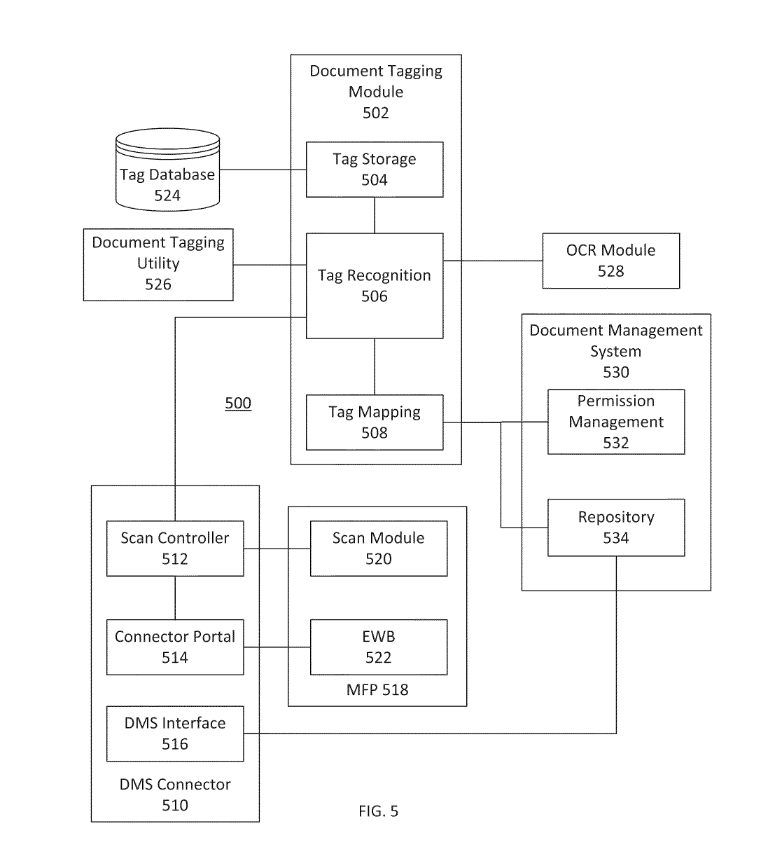

Turning now to FIG. 5 there is shown a functional diagram of the system 500 for document tag based destination prompting and auto routing. The system 500 is implemented in software and includes a document tagging module 502 incorporating a tag storage engine 504, a tag recognition engine 506 and a tag mapping engine 508, a document management system connector 510 incorporating a scan controller 512, a connector portal 514 and a document management system interface 516, a multifunction peripheral 518 incorporating a scan module 520 and an embedded web browser 522, a tag database, a document tagging utility 526, an OCR (optical character recognition) module 528 and a document management system 530 incorporating a permission management subsystem 532 and a repository 534. Each of the elements may be either directly connected or connected by a network.

The document tagging module 502 associates tags with particular document storage locations, for example, in the document management system 530 and its repository 534. The document tagging module 502 may be implemented in the controller, such as system 400, within the document processing device or in a separate general purpose computer or thin client in communication with the document processing device. The document tagging module 502 provides the capability to recognize tags, to associate tags with a particular storage location and to store the tags and their accompanying association for later use in directing electronic documents to the appropriate repository or location in the repository.

In order to carry out each of the document tagging module 502 functions, the document tagging module includes a number of engines. The tag storage engine 504 stores the associated document tag and document storage location combination, once it is created by the tag mapping engine 508. The tag storage engine 504 directs the created document tags for storage in the tag database 524.

The tag recognition engine 506 is also a part of the document tagging module 502 and serves two functions. First, as tags are being created, the tag recognition engine 506 identifies text or other symbols that may be used as document tags within electronic documents. This is accomplished in conjunction with the OCR module 528 which identifies text that may include document tags. Second, the tag recognition engine 506 is used after document tags have been created and associated with a document storage location, to identify tags in electronic documents and to route those documents automatically or according to a user response to a prompt to the associated document storage location such as the repository 534.

The tag mapping engine 508 uses document tags that are created using the tag recognition engine 506 and stored in the tag database 524 using the tag storage engine 504 to identify the location associated with the document tag in the document management system 530, such as the repository 534. The tag mapping engine 508 also serves to direct a multifunction peripheral to the appropriate location in the repository 534 when electronic documents incorporating identified tags are provided to the document management system connector 510.

The document management system connector 510 operates as an interface between the multifunction peripheral 518 and the document management system 530. The document management system connector 510 includes a scan controller 512 that connects the scan module 520 of the multifunction peripheral 518 with the tag recognition engine 506 of the document tagging module 502.

The document management system connector 510 also includes a connector portal 514 that acts as a control interface accessible by the embedded web browser 522 of the multifunction peripheral 518 to enable the document management system 530 to be controlled from the multifunction peripheral 518. This embedded web browser 522 may seamlessly present a user interface on the multifunction peripheral 518 even if it is created by and operations requested are conducted by the document management system connector 510. In this way, the multifunction peripheral 518 may communicate directly with the document management system 530, including providing any login credentials and any other information necessary for a multifunction peripheral user's interaction with the document management system 530. The document management system interface 516 enables the multifunction peripheral 518 to store documents in the repository 534 associated with the document management system 530 through interactions using the embedded web browser 522.

The multifunction peripheral 518 may be the multifunction peripheral 110 of FIG. 1 or the MFP 200 of FIG. 2. It may include a number of elements in addition to the scan module 520 and the embedded web browser 522. The scan module 520 may be the scanner interface 226, scanner engine 266 and scanner hardware 286. The system 400 may also be used to implement some or all of the scan module 520.

The scan module 520 enables the multifunction peripheral 518 to scan physical documents into electronic documents. Then, using the OCR module 528, to recognize and store characters and words in the electronic documents for identification as document tags or for use as document tags. The embedded web browser 522 may be used as a front-end to provide access to the various functionalities implemented by the multifunction peripheral 518 and to provide access to functionalities provided by the document tagging module 502, document management system connector 510 and document management system 530. An internal web-based interface may be accessed by an associated user of the embedded web browser 522.

The tag database 524 stores the document tags and associated document storage locations, for example in the repository 534. The tag database 524 may also store other parameters such as whether or not a user wishes to be prompted prior to storage or document parameters related to documents including a particular document tag. These parameters may include various types of metadata that is added to the tag database or the repository 534 relative to the stored electronic documents. These parameters may include document titles or portions of document titles, document authors, or projects to which the document is related. The tag database 524 is accessed using the tag storage engine 504.

The document tagging utility 526 may be a stand-alone software application that may be used on an associated personal, server or other computer to create and manage document tag and document storage location associations. The document tagging utility 526 may be implemented as an aspect of the user interface of the document processing device 522 or the document management system connector 510. The document tagging utility 526, for example, may be used to input new tags, to identify the location in incoming documents to look for document tags and to set or amend storage locations for associated document tags.

The OCR module 528 may be implemented on a server or as a part of the multifunction peripheral 518, such as the multifunction peripheral 110. The OCR module 528 may be implemented using the OCR server 140. Alternatively, the OCR module 528 may be implemented as a part of the document tagging module 502 on the OCR server 140 or as a part of the multifunction peripheral system 400.

The document management system 530 is a system used to organize and store large numbers of documents. The repository 534 is intended for use as a data store and may be hard disk drives local to the document management system 530 or they may be remote network storage. Alternatively, the repository 534 may be some form of cloud storage or purchased, as-needed storage on a document management system 530 shared by a number of groups or organizations. The repository 534 may be backed up on a regular basis.

The document management system 530 may include a database as a part of the repository 534. This database enables the documents stored in the repository 534 to be identified by a number of characteristics such as creation date, title, author, last edit date, or control numbers associated with particular products. The repository 534 may include capabilities such as version tracking, tracking the users who have accessed and edited the documents and the precise times which documents were opened, edited or closed. The document management system 530 may enable cross-linking of related documents in addition to full-text or parameter-based searching and indexing of documents.

The document management system 530 may be the document management system 120. The document management system 530 may be implemented in hardware, software or a combination of both. It may be implemented, in whole or in part, by a processor running software on a stand-alone server, as a part of another server or using software-as-a-service.

The document management system 530 includes a permission management subsystem 532 that grants authorized users access to the repository 534. Unauthorized users are not granted access to the document management system 530. The permission management subsystem 532 also determines what level of access to documents stored in the repository 534 various users have. For example, some users may be able to read, write, overwrite and append documents, while others may only be able to read documents.

The document management system 530 accepts documents, as-directed by the document tagging module 502, to be stored in the repository 534 as directed by the tag recognition engine 506 based upon data stored in the tag database 524. In this way, documents may be automatically stored or stored after a prompt to the user to a particular location in the repository 534 as indicated by the document tagging module 502.

Description of Processes

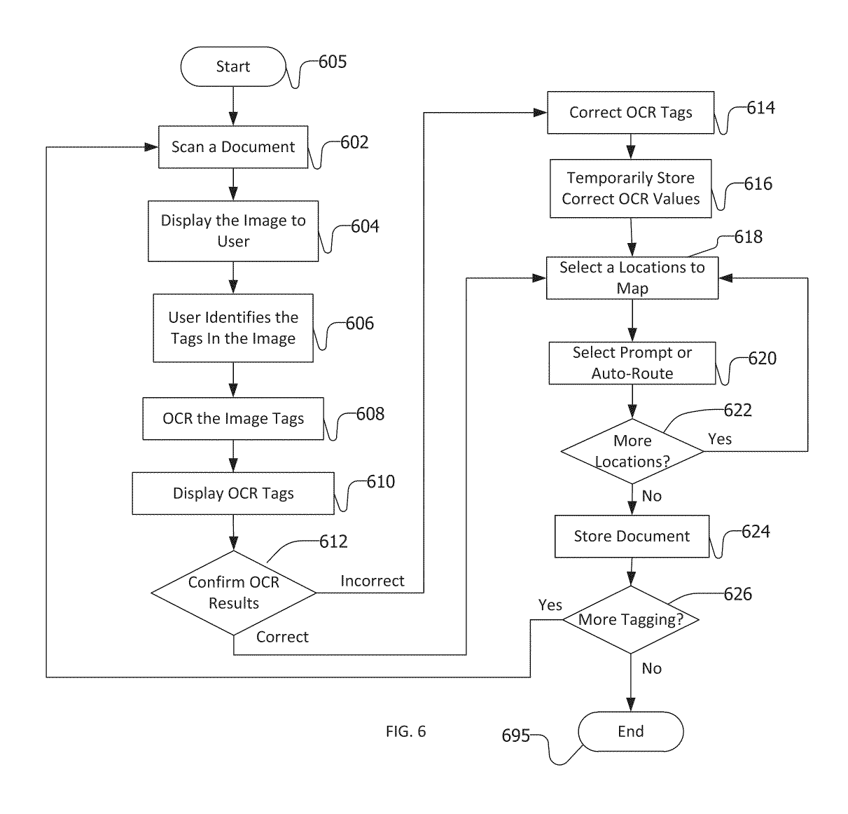

Referring now to FIG. 6 there is shown a flowchart for creation of document tags. This is the process by which document tags are associated with document storage locations. Initially a document is scanned 602. An electronic document is created from a physical document. Scanning need not occur when the document has been received or generated in electronic form.

An image of the electronic document is displayed to the user 604. This may occur using a display associated with the user interface of the multifunction peripheral. Alternatively the display may be on a display associated with a personal computer utilized by the user, for example using the document tagging utility 526.

The user may then identify document tags in the image of the electronic document 606. Using the user interface associated with the multifunction peripheral, the user may highlight a particular portion of the image that includes the document tag. The user may create a rectangular selection area around the location incorporating the document tag. The user may similarly highlight a particular portion of the image using stand-alone software such as the document tagging utility 526.

The document tag may take one of any number of forms. The document tag may be a text-based tag inherent to the document. For example the document tag may be a control number associated with a document or series of documents that is incorporated into a pre-determined portion of each document of a particular type. A document tag may be the title of a project with which a number of documents will be associated. The document tag may be the name of a particular individual or product. Any of these types of document tags may be used. Document tags may take the form of a particular image, logo or unique identifier such as a bar-code. Optical character recognition may be replaced by other software designed to identify the particular type of image, logo or unique identifier.

The OCR module 528 then performs optical character recognition on the portion of the image that the user has identified as including document tags 608. This optical character recognition, focused on a particular document portion identified by the user as including the document tag, saves time and computing resources in creating and searching for document tags. The entire electronic document may be searched for document tags and the user may then select the location or tag from among the textual elements identified.

The potential document tags identified by the optical character recognition are then displayed to the user 610, either on the user interface associated with the document processing device or on a display associated with the document tagging utility 526. The user may then confirm that the optical character recognition results accurately identified the document tag 612. Correct recognition occurs when the correct document tags have been identified and, in the case of text-based document tags, when they are correctly-spelled.

If the document tags are not correct, the user is provided with an opportunity to correct the optical character recognition document tags 614 by, for example, correcting the spelling, eliminating unnecessary characters or words from the document tags or otherwise correcting the document tags so that they may be recognized appropriately by the tag recognition engine 506 in the future. Once corrected, the corrected optical character recognition values are temporarily stored 616.

If the optical character recognition results are correct or once the correct values are temporarily stored, the storage location or locations to be associated with the document tag or tags are selected 618. This may be done using the user interface on the document processing device or, alternatively, using the document tagging utility 526.

The user may then indicate a desire to be prompted or to auto-route documents including this document tag or these document tags to the selected storage location or locations 620. The user may determine whether it is desirable to be prompted to confirm the location to which electronic documents are to be routed upon receipt of a new electronic document and identification of a document tag and associated document storage location. If a prompt is not desired, the system may be set to automatically route documents in which document tags are identified to the previously-identified storage location.

The user is then presented, either by a user interface associated with the multifunction peripheral 518 or the document tagging utility 526, with the option to identify more locations 622 to be associated with each document tag. Each of the document tags may be associated with one or more storage locations. The electronic document will be stored in each of the identified locations or a user will be prompted, if desired, to determine whether to store the document in each of the locations in turn.

Once the locations are selected, the document and the created document tag is stored to the location or locations set 624. The document storing may be separated from the tag storing. The document may be stored at this stage so that a user may simultaneously take care of creating document tags for future documents and complete the process of storing the document to the desired location in one process. If more tagging of documents is desired 626, a user may do so by scanning another document 602 to begin the process again. Otherwise, the process of creating document tags may end at this point.

The flow chart of FIG. 6 has both a start 605 and an end 695, but the process is cyclical in nature. Portions of the process may be accomplished in parallel or serially. Multiple instances of the process may be taking place in parallel or serially.

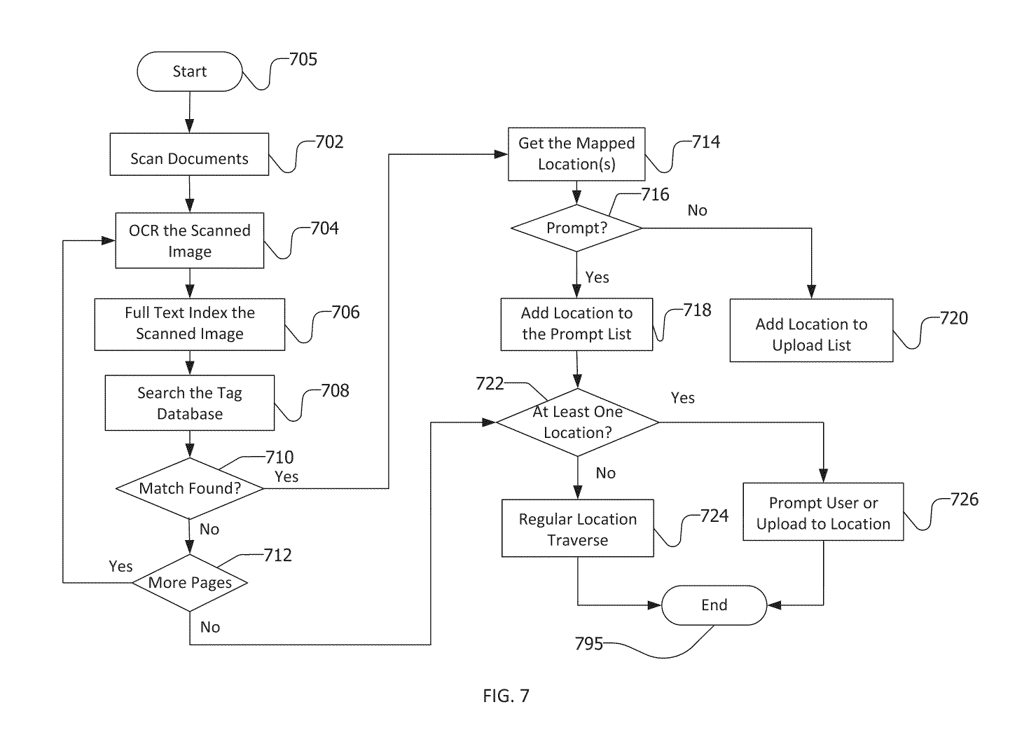

Turning now to FIG. 7 there is shown a flowchart for destination prompting and auto routing. This is the process by which document tags are detected in electronic documents. The document tags may be used to prompt or automatically route documents to storage locations. Physical documents are scanned 702 to create electronic documents. These documents consist of only a scanned image.

Optical character recognition is performed on the scanned image 704. This enables the multifunction peripheral 518 or associated document tagging module 502 to full-text index the electronic document 706 in order to identify document tags in the electronic document. Once a full-text index is complete, the tag database 524 is searched for document tags that are found within the electronic document 708. If a match is not found, optical character recognition may be performed on additional pages or documents 712 in search of document tags.

If a match is found 710, then the tag database 524 is accessed in order to get the mapped location or locations 714. The tag database 524 is also checked to determine if a user prompt before storing the electronic documents in the mapped locations is desired or not 716. If prompting is desired, then the location or locations will be added to the prompt list 718. The prompt list is a list of locations for which the user will be prompted to determine whether storage at that location is desired by the user. If prompting is not desired, the location or locations are added to the upload list 720. The documents will be uploaded from the multifunction peripheral to the previously-identified storage locations.

If no location either for prompting or uploading is detected for storage of electronic documents in view of the document tags identified 722 is detected, then the document may be stored in regular default location 724. The default location may be a default folder in the repository or may be a default network location. The default location traverse 724 may prompt the user to input a location for storage.

If at least one location for prompting or uploading is detected for storage of electronic documents in view of the document tags identified 722 is detected, then the user is prompted to confirm storage at a location (or to alter the previously-identified location) or the electronic document is automatically uploaded to the storage location 726, such as a folder or folders in the repository 534. A series of prompts may be initiated if there are a number of document tags identified or if there are a series of document storage locations. A series of uploads may also be initiated to various storage locations for the electronic documents if several documents are set for storage or if the document tags identify a series of locations to which to store the electronic documents in the repository or otherwise. The documents are then all uploaded to the repository 634 as directed by the tags or as directed by the user in response to the prompts.

The flow chart of FIG. 7 has both a start 705 and an end 795, but the process is cyclical in nature. Portions of the process may be accomplished in parallel or in serial. Multiple instances of the process may be taking place in parallel or in serial.

Closing Comments

Throughout this description the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for electronic document routing comprising:
accepting an electronic document including a document tag into a multifunction peripheral;
displaying the electronic document to a user on a display associated with the multifunction peripheral;
accepting input identifying the location of the document tag within the electronic document;
performing optical character recognition on the location to detect the document tag;
accessing a database to obtain a predetermined one of a location to which to store electronic documents incorporating the document tag and an indicia that a user should be prompted for a location when the document tag is detected; and
storing the electronic document in electronic storage based upon the location.

2. The method of claim 1 further comprising:
displaying the document tag to the user on the display associated with the multifunction peripheral; and
accepting user correction of the document tag.

3. The method of claim 1 wherein each of the elements is repeated for a second document tag within the electronic document.

4. The method of claim 1 wherein the location is selected by a user by:
accepting an electronic document including the document tag;
accepting input identifying the document tag within the electronic document; and
associating the location to which electronic documents including the document tag are to be stored with the document tag.

5. The method of claim 1 wherein the indicia is predetermined by a user by:
accepting an electronic document including the document tag;
accepting input identifying the document tag within the electronic document; and
associating the indicia to prompt with the document tag in a database.

6. The method of claim 1 wherein each of the elements is repeated for a plurality of electronic documents.

7. The method of claim 1 wherein a plurality of locations are associated with the document tag.

8. An apparatus, including a processor and associated memory, the apparatus including software for electronic document routing that when executed by the processor causes the processor to:
accept an electronic document including a document tag into a multifunction peripheral;
display the electronic document to a user on a display associated with the multifunction peripheral;
accept input identifying the location of the document tag within the electronic document;
perform optical character recognition on the location to detect the document tag;
access a database to obtain a predetermined one of a location to which to store electronic documents incorporating the document tag and an indicia that a user should be prompted for a location when the document tag is detected; and
store the electronic document in electronic storage based upon the location.

9. The apparatus of claim 8 wherein the instructions further cause the processor to:
display the document tag to the user on the display associated with the multifunction peripheral; and
accept user correction of the document tag.

10. The apparatus of claim 8 wherein the instructions further cause the processor to repeat each element for each of a plurality of document tags within the electronic document.

11. The apparatus of claim 8 wherein the location is selected by a user with instructions that further cause the processor to:
accept an electronic document including the document tag;
accept input identifying the document tag within the electronic document; and
associate the location to which electronic documents including the document tag are to be stored with the document tag.

12. The apparatus of claim 8 wherein the indicia is predetermined by a user with instructions that further cause the processor to:
accept an electronic document including the document tag;
accept input identifying the document tag within the electronic document; and
associate the indicia to prompt with the document tag in a database.

13. The apparatus of claim 8 wherein the processor is further instructed to repeat each element for a plurality of electronic documents.

14. The apparatus of claim 8 wherein a plurality of locations are associated with the document tag.

15. A multifunction peripheral system comprising a document tagging module for accepting an electronic document including a document tag, the document tagging module including:
a tag recognition engine for identifying the document tag within the electronic document;
a tag mapping engine for associating a location to which electronic documents including the document tag are to be stored with the document tag; and
a tag storage engine for storing the electronic document in electronic storage based upon the location associated with the document tag.

16. The multifunction peripheral system of claim 15 further comprising an optical character recognition module for performing optical character recognition on electronic documents.

17. The multifunction peripheral system of claim 15 further comprising a document management system to which the identified electronic documents may be directed including a permission management system for identifying authorized users of the document management system and a repository for storing electronic documents.

18. The multifunction peripheral system of claim 17 further comprising a multifunction peripheral including a scan module for scanning physical documents into electronic documents and an embedded web browser for directing the operation of the document processing device.

19. The multifunction peripheral system of claim 18 further including a document management system connector to enable interaction between the document processing device, the document tagging module and the document management system, the document management system connector including:
a scan controller to direct scanned electronic documents to the tag recognition engine;
a connector portal to enable control of the document management system connector from the document processing device; and
a document management system interface for enabling interaction between the document processing device and the repository.

20. The multifunction peripheral system of claim 15 further including a document tagging utility to create document tags associated with a storage location and a tag database to store the document tags associated with a storage location.
